(19) United States
(12) Patent Application Publication
(10) Pub. No.: US 2015/0366376 A1
(43) Pub. Date: Dec. 24, 2015

(54) Display for Merchandising Hair Color Products

(71) Applicant: The Procter & Gamble Company, Cincinnati, OH (US)

(72) Inventor: Calli Elizabeth FILIPPINI, Maderia, OH (US)

(21) Appl. No.: 14/743,309

(22) Filed: Jun. 18, 2015

Related U.S. Application Data
(60) Provisional application No. 62/014,999, filed on Jun. 20, 2014.

(51) Int. Cl. A47F 7/28; A47F 7/00; G09F 23/06; A47F 1/12

(52) U.S. Cl. CPC A47F 7/28; A47F 1/125; A47F 7/0007; G09F 23/06

(57) ABSTRACT

A display for merchandising hair color kits including multiple product compartments each including a supporting tray, a left side wall, a right side wall, a compartment opening, a stopping element, and one or more hair color kits. The compartment opening has a height of from about 4.75 cm to about 12 cm. The one or more hair color kits each has a vertical face. The vertical face has a height of from about 4.5 cm to about 9 cm. Greater than 25% of the vertical face is an illustration of a hair color shade. Less than 25% of the vertical face is an illustration of a human body part.

### FIELD OF THE INVENTION

Described herein is a display for merchandising hair color products. More particularly, described herein is a display for merchandising hair color products comprising multiple product compartments.

### BACKGROUND OF THE INVENTION

Various displays are known for merchandising hair color products. These displays merchandise hair color kits having a vertical height longer than their depth. Displays such as these have drawbacks. These drawbacks include (1) occupying unnecessary shelf space and (2) making hair color shade selection difficult for consumers.

Based on the foregoing, there is a need for a display for merchandising hair color products which occupies less shelf space and (2) simplifies the hair color shade selection process for consumers.

### SUMMARY OF THE INVENTION

According to an embodiment of the invention, there is provided a display for merchandising hair color kits comprising multiple product compartments each comprising a supporting tray, a left side wall, a right side wall, a compartment opening, a stopping element, and one or more hair color kits; wherein the compartment opening comprises a height of from about 4.75 cm to about 12 cm; wherein the one or more hair color kits each comprise a vertical face; wherein the vertical face comprises a height of from about 4.5 cm to about 9 cm; wherein greater than 25% of the vertical face is an illustration of a hair color shade; and wherein less than 25% of the vertical face is an illustration of a human body part selected from the group consisting of a human face, a human neck, a human shoulder, and combinations thereof.

According to yet another embodiment of the invention, there is provided a display for merchandising hair color kits comprising multiple product compartments each comprising a supporting shelf, a left side wall, a right side wall, a compartment opening, and one or more hair color kits; wherein the supporting shelf supports the weight of the one or more hair color kits; wherein the compartment opening comprises a height of from about 4.75 cm to about 11 cm; wherein the one or more hair color kits each comprise a vertical face; wherein the vertical face comprises a height of from about 4.5 cm to about 8 cm; and wherein greater than 40% of the vertical face is an illustration of a hair color shade.

These and other features, aspects, and advantages of the present invention will become evident to those skilled in the art from a reading of the present disclosure.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings in which:

FIG. 1 is a front view of an embodiment of the display;

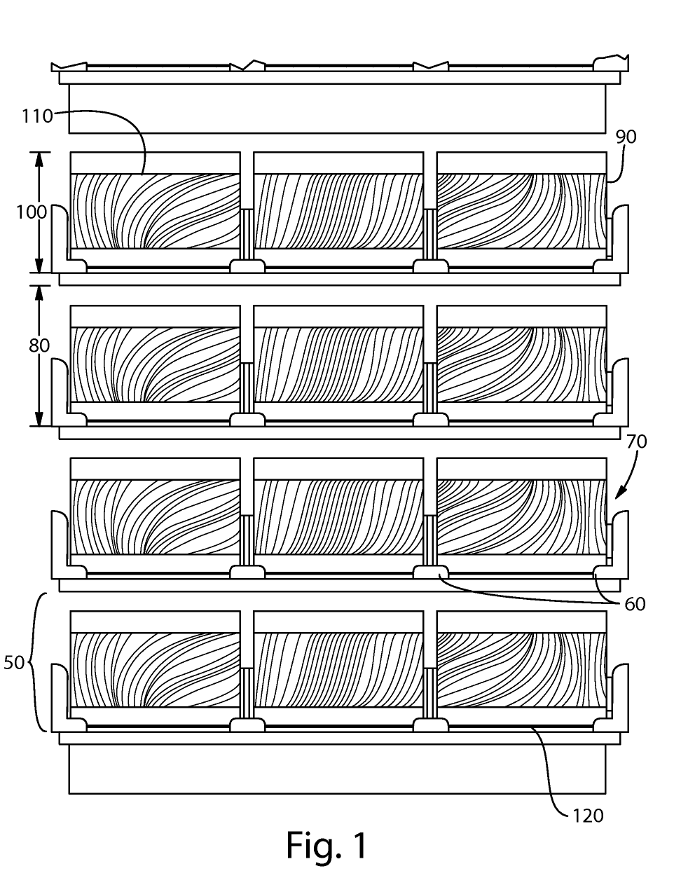

FIG. 2 is a right side view of an embodiment of the display;

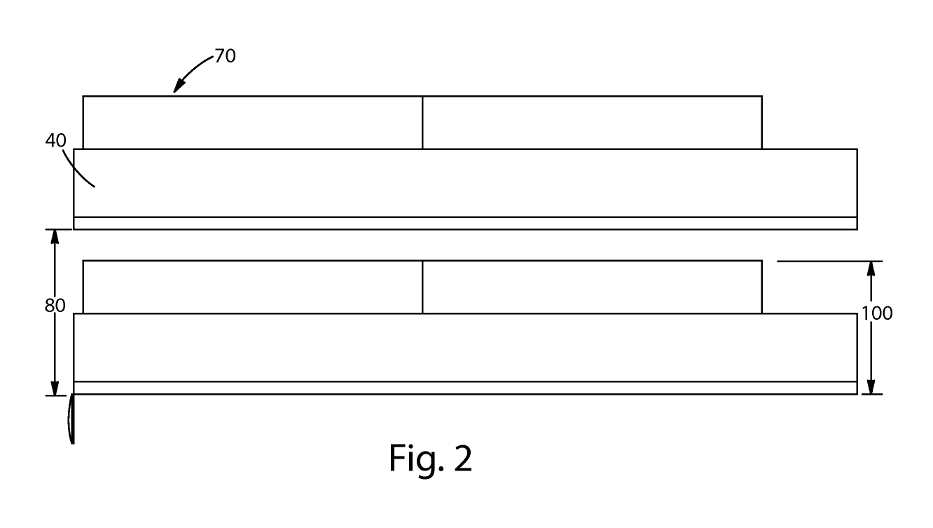

FIG. 3 is a front view of an embodiment of the display without the one or more hair color kits; and

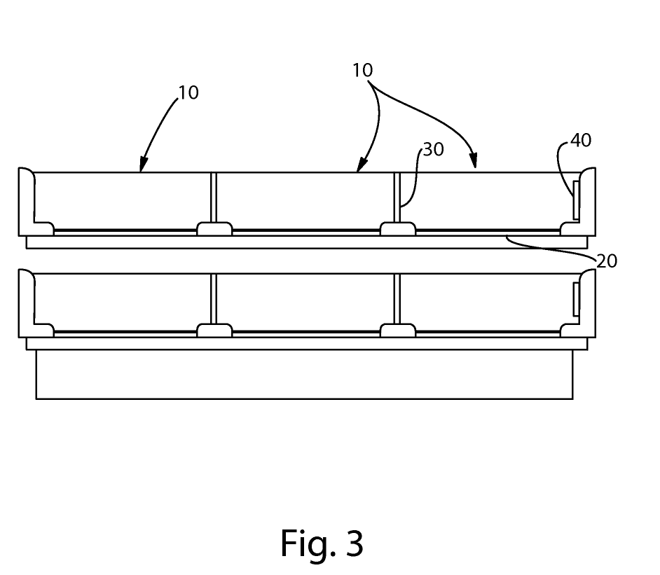

FIG. 4 is a perspective view of an embodiment of the display wherein one of the product compartments does not comprise the one or more hair color kits.

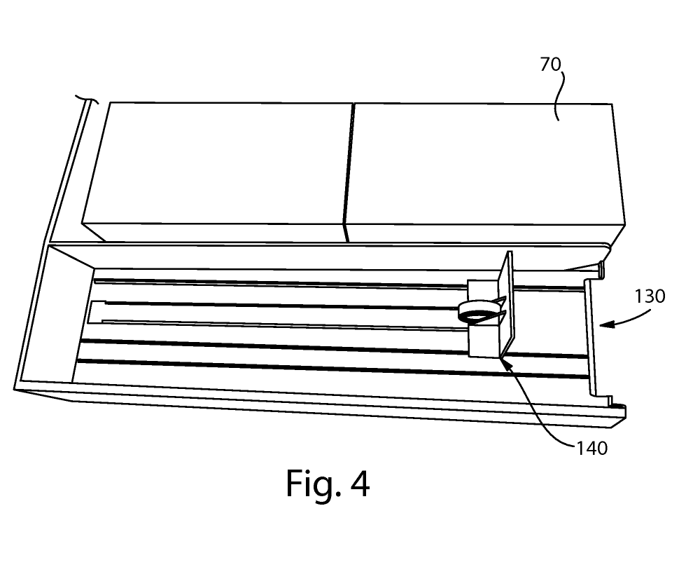

### DETAILED DESCRIPTION OF THE INVENTION

In all embodiments described below, all percentages are by weight of the total composition, unless specifically stated otherwise. All ratios are weight ratios, unless specifically stated otherwise. The number of significant digits conveys neither a limitation on the indicated amounts nor on the accuracy of the measurements. All numerical amounts are understood to be modified by the word “about” unless otherwise specifically indicated. Unless otherwise indicated, all measurements are understood to be made at 25° C. and at ambient conditions, where “ambient conditions” means conditions under about one atmosphere of pressure and at about 50% relative humidity. All such weights as they pertain to listed ingredients are based on the active level and do not include carriers or by-products that may be included in commercially available materials, unless otherwise specified.

The term “comprising,” as used herein, means that other steps and other ingredients which do not affect the end result can be added. This term encompasses the terms “consisting of” and “consisting essentially of.” The compositions and methods/processes of the present invention can comprise, consist of, and consist essentially of the elements and limitations of the invention described herein, as well as any of the additional or optional ingredients, components, steps, or limitations described herein.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. The term “weight percent” may be denoted as “wt. %” herein.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The display 200 for merchandising hair color kits may comprise multiple product compartments 10 each comprising (1) a supporting tray 20, (2) a left side wall 30, (3) a right side wall 40, (4) a compartment opening 50, (5) a stopping element 60, and (6) one or more hair color kits 70.

The left side wall 30 and the right side wall 40 may extend from the back of the multiple product compartments 10 to the front of the multiple product compartments 10. The left side wall 30 and the right side wall 40 may be of any height, shape, contour, or profile that is suitable for separating the one or more hair color kits 70 into the multiple product compartments 10 which make up the display 200.

In an embodiment, the stopping element 60 may be any element known in the art for stopping a product from being pushed off of a shelf.

The compartment opening 50 may comprise a height 80 of from about 4.75 cm to about 12 cm, alternatively from about 5 cm to about 10 cm, alternatively from about 5.5 cm to about 10 cm, alternatively from about 6 cm to about 9 cm, alternatively from about 6 cm to about 8 cm, and alternatively from about 7 cm to about 9 cm.

The one or more hair color kits 70 may each comprise a vertical face 90. The vertical face 90 may comprise a height 100 of from about 4.5 cm to about 9 cm, alternatively from about 5 cm to about 7 cm, alternatively from about 5 cm to about 6.5 cm, alternatively from about 5.5 cm to about 6.5 cm, alternatively from about 7 cm to about 8 cm, alternatively about 6 cm, and alternatively about 7.5 cm.

In an embodiment, greater than 25% of the vertical face 90 may be an illustration of a hair color shade 110, alternatively greater than 35% of the vertical face 90 may be an illustration of the hair color shade 110, alternatively greater than 45% of the vertical face 90 may be an illustration of the hair color shade 110, alternatively greater than 55% of the vertical face 90 may be an illustration of the hair color shade 110, alternatively great than 65% of the vertical face 90 may be an illustration of the hair color shade 110. The illustration of the hair color shade 110 may be an illustration of human hair.

In an embodiment, less than 25% of the vertical face 90 may be an illustration of a human body part selected from the group consisting of a human face, a human neck, a human shoulder, and combinations thereof, alternatively less than 15% of the vertical face 90 may be an illustration of a human body part selected from the group consisting of a human face, a human neck, a human shoulder, and combinations thereof, alternatively less than 10% of the vertical face 90 may be an illustration of a human body part selected from the group consisting of a human face, a human neck, a human shoulder, and combinations thereof, alternatively less than 5% of the vertical face 90 may be an illustration of a human body part selected from the group consisting of a human face, a human neck, a human shoulder, and combinations thereof, alternatively the vertical face 90 may be substantially free of the illustration of the human body part selected from the group consisting of the human face, the human neck, the human shoulder, and combinations thereof, and alternatively the vertical face 90 is free of the illustration of the human body part selected from the group consisting of the human face, the human neck, the human shoulder, and combinations thereof.

In an embodiment, the multiple product compartments 10 may display the illustrations of the hair color shades 110 on a scale from dark hair color shades to light hair color shades. The multiple product compartments 10 may each comprise a mechanical mechanism 140 for advancing the one or more hair color kits 70 forward when one hair color kit 70 is removed.

In an embodiment, the one or more hair color kits 70 may comprise a first kit, wherein the first kit comprises a base 120, wherein the supporting tray 20 comprises a lifting gap 130, and wherein the lifting gap 130 exposes a portion of the base 120 for lifting. In an embodiment, the portion of the base 120 may be exposed for lifting the first kit over the stopping element 60. The mechanical mechanism 140 may have a force of from about 0.15 kg to about 1.25 kg, alternatively from about 0.15 kg to about 1.1 kg, alternatively from about 0.3 kg to about 1.15 kg, alternatively from about 0.3 kg to about 1.1 kg, alternatively from about 0.5 kg to about 1.1 kg.

In an embodiment, the mechanical mechanism 140 may be mounted on the base 120 using any known mounting technique. In an embodiment, the mechanical mechanism 140 may be a push urging element connected to a pusher surface. One end of the pushing element may be secured to the base 120 near the front edge of the base 120, and the opposing end of the pushing element, which may be a coiled end, may be positioned behind the pusher surface to urge the pusher surface toward the front of the product compartment 10, as known in the art.

The mechanical mechanism 140 may be mounted on the left side wall 30 or the right side wall 40 using any known mounting technique. In an embodiment, the mechanical mechanism 140 may be a push urging element connected to a pusher surface. One end of the pushing element may be secured to the left side wall 30 or the right side wall 40 near the front edge of the left side wall 30 or the right side wall, and the opposing end of the pushing element, which may be a coiled end, may be positioned behind the pusher surface to urge the pusher surface toward the front of the product compartment 10, as known in the art.

Alternative mechanical mechanisms 140 may be found in U.S. Pat. No. 7,922,010, which is incorporated herein by reference.

The force exerted by the mechanical mechanism 140 may be measured using Hooke's law. Hooke's law is a principle of physics that states that the force (F) needed to extend or compress a spring by some distance (X) is proportional to that distance. That is, (F)=(k)(X), wherein (k) is a constant factor characteristic of the spring, its stiffness.

In an embodiment, the force may be strong enough to advance the one or more hair color kits 70 forward. In an embodiment, the force may not be so strong that the one or more hair color kits 70 are crushed.

The one or more hair color kits 70 may comprise a hair treatment composition selected from the group consisting of hair colorant compositions, hair bleaching compositions, highlighting compositions, conditioning compositions, and combinations thereof. The hair treatment composition may be individually packaged inside of the hair color kit 70. In an embodiment, the one or more hair color kits 70 may each comprise two or more hair treatment compositions which require mixing prior to application.

Variations and modifications of the foregoing are within the scope of the display described herein. For example, one of skill in the art will understand that multiples of the described components may be used in stores and in various configurations.

It is further noted that terms like “alternatively,” “usually”, “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the hair care compositions described herein.

For the purposes of describing and defining the hair care compositions described herein it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the hair care compositions described herein are identified herein as preferred or particularly advantageous, it is contemplated that the hair care compositions described herein are not necessarily limited to these preferred aspects of the invention.

All documents cited in the Detailed Description of the Invention are, in relevant part, incorporated herein by reference; the citation of any document is not to be construed as an admission that it is prior art with respect to the hair care compositions described herein. To the extent that any meaning or definition of a term in this written document conflicts with any meaning or definition of the term in a document incorporated by reference, the meaning or definition assigned to the term in this written document shall govern.

What is claimed is:

1. A display for merchandising hair color kits comprising multiple product compartments each comprising a supporting tray, a left side wall, a right side wall, a compartment opening, a stopping element, and one or more hair color kits;
wherein the compartment opening comprises a height of from about 4.75 cm to about 12 cm;
wherein the one or more hair color kits each comprise a vertical face;
wherein the vertical face comprises a height of from about 4.5 cm to about 9 cm;
wherein greater than 25% of the vertical face is an illustration of a hair color shade; and
wherein less than 25% of the vertical face is an illustration of a human body part selected from the group consisting of a human face, a human neck, a human shoulder, and combinations thereof.

2. The display of claim 1, wherein less than 15% of the vertical face is the illustration of the human body part selected from the group consisting of the human face, the human neck, the human shoulder, and combinations thereof.

3. The display of claim 1, wherein less than 5% of the vertical face is the illustration of the human body part selected from the group consisting of the human face, the human neck, the human shoulder, and combinations thereof.

4. The display of claim 1, wherein the vertical face is substantially free of the illustration of the human body part selected from the group consisting of the human face, the human neck, the human shoulder, and combinations thereof.

5. The display of claim 1, wherein the vertical face is free of the illustration of the human body part selected from the group consisting of the human face, the human neck, the human shoulder, and combinations thereof.

6. The display of claim 1, wherein greater than 35% of the vertical face is the illustration of the shade of hair color.

7. The display of claim 1, wherein greater than 45% of the vertical face is the illustration of the hair color shade.

8. The display of claim 1, wherein greater than 55% of the vertical face is the illustration of the hair color shade.

9. The display of claim 1, wherein the illustration of the hair color shade is an illustration of human hair.

10. The display of claim 1, wherein the multiple product compartments display the illustrations of the hair color shades on a scale from dark hair color shades to light hair color shades.

11. The display of claim 1, wherein the multiple product compartments each comprise a mechanical mechanism for advancing the one or more hair color kits forward when one hair color kit is removed.

12. The display of claim 1, wherein the one or more hair color kits comprises a first kit, wherein the first kit comprises a base, wherein the supporting tray comprises a lifting gap, and wherein the lifting gap exposes the base for lifting.

13. A display for merchandising hair color kits comprising multiple product compartments each comprising a supporting shelf, a left side wall, a right side wall, a compartment opening, and one or more hair color kits;
wherein the supporting shelf supports the weight of the one or more hair color kits;
wherein the compartment opening comprises a height of from about 4.75 cm to about 11 cm;
wherein the one or more hair color kits each comprise a vertical face;
wherein the vertical face comprises a height of from about 4.5 cm to about 8 cm; and
wherein greater than 40% of the vertical face is an illustration of a hair color shade.

14. The display of claim 13, wherein less than 15% of the vertical face is an illustration of a human body part selected from the group consisting of a human face, a human neck, a human shoulder, and combinations thereof.

15. The display of claim 13, wherein the compartment opening comprises a height of from about 5 cm to about 10 cm.

16. The display of claim 13, wherein less than 5% of the vertical face is the illustration of the human body part selected from the group consisting of the human face, the human neck, the human shoulder, and combinations thereof.

17. The display of claim 13, wherein the illustration of the hair color shade is an illustration of human hair.

18. The display of claim 13, wherein the multiple product compartments each comprise a mechanical mechanism for advancing the one or more hair color kits forward when one hair color kit is removed.

19. The display of claim 18, wherein the mechanical mechanism has a force of from about 0.15 kg to about 1.25 kg.

20. The display of claim 13, wherein the one or more hair color kits comprises a first kit, wherein the first kit comprises a base, wherein the supporting tray comprises a lifting gap, and wherein the lifting gap exposes the base for lifting.
